(19) United States
(12) Patent Application Publication
(10) Pub. No.: US 2010/0034933 A1
(43) Pub. Date: Feb. 11, 2010

(54) STABLE MUFFIN BATTERS AND METHODS FOR MAKING SAME

(75) Inventors: Jon Crawford, Hudson, OH (US); Judith Ann Mondello, Wadsworth, OH (US)

Correspondence Address: Calfee, Halter & Griswold LLP, 800 Superior Ave., Sts. 1400, Cleveland, OH, 44114, US

(73) Assignee: THE J.M. SMUCKER CO., Orrville, OH (US)

(21) Appl. No.: 12/199,959

(22) Filed: Aug. 28, 2008

Related U.S. Application Data
(60) Provisional application No. 61/087,054, filed on Aug. 7, 2008.
(60) Provisional application No. 61/089,615, filed on Aug. 18, 2008.

(51) Int. Cl. A21D 10/04; B65D 77/04

(52) U.S. Cl. 426/108; 426/552; 426/553

(57) ABSTRACT

Muffin batters that are substantially stable to temperature fluctuations experienced in a commercial retail setting are provided. The muffin batters can be balked into muffins having desirable flavor and texture profiles as well as having other desirable organoleptic properties. The muffin batters can also be combined with a muffin topping to provide a muffin mix. In one embodiment, a muffin batter having substantial stability to temperature fluctuations experienced in a commercial retail setting includes from about 7.5% to about 22.5% of a flavorant mix; from about 19% to about 22% water; from about 15% to about 27% of one or more types of flour; from about 16.5% to about 21.0% sweetener; from about 10.5% to about 13.5% liquid whole eggs; from about 8.5% to about 10.5% oil; from about 1.2% to about 1.9% of a leavening system comprising one or more chemical leavening agents; from about 0.0% to about 1.5% of emulsifier agent; and from about 0.2% to about 0.5% carrageenan. In another embodiment, a muffin mix combines the muffin batter with a muffin topping that includes about 37% sugar, from about 22% to about 29% flour, about 21-22% of rolled oats, from about 12% to about 18% shortening, and one or more additional ingredients selected from butter flavor and cinnamon spice. Also provided are muffin packages comprising a tray containing individual serving-sized portions of the muffin batters and methods for making the muffin batters.

### CROSS REFERENCE TO RELATED APPLICATIONS

The present application claims priority to, and any other benefit of, U.S. Provisional Patent Application Ser. No. 61/087,054, filed Aug. 8, 2008, and entitled MUFFIN BATTERS HAVING TEMPERATURE STABLE VISCOSITIES AND METHODS OF MAKING SAME (Attorney Docket 26416/05435); and U.S. Provisional Patent Application Ser. No. 61/089,615, filed Aug. 18, 2008, and entitled MUFFIN BATTERS HAVING STABLE VISCOSITIES AND METHODS OF MAILING SAME (Attorney Docket 26416/05435), the entire contents of both, which are hereby incorporated by reference.

### BACKGROUND

Muffins are some of the most popular desserts in the U.S., served for breakfast, lunch, dinner, and as a between meal snack. They are a popular food item for all situations ranging from casual affairs to formal events. While many people enjoy baking muffins at home, many consumers prefer the ease and convenience that pre-made muffin batters and pre-formulated mixes provide rather than preparing muffins from scratch. Not only are the muffin batters and mixes convenient, since they generally require only a few additional ingredients be added followed by mixing and baling to form the muffin, they also yield consistent, high quality muffins each time, with minimal preparation time. Additionally, frozen muffin “pucks”—i.e., pre-mixed muffin batter that is portioned into individual muffin quantities and frozen—are known and used in commercial retail settings where there is an insignificant period of time between removal of the frozen muffin pucks from a freezer until the time they are placed in an oven for baking into muffins.

Applicants have appreciated that a property of conventional muffin batters is that they typically become increasingly flowable with increasing temperature, meaning they do not have freeze-thaw stability over temperature ranges and fluctuations experienced in commercial retail settings. In the absence of any thickening agents, the viscosity of a conventional batter drops dramatically as the temperature increases from freezing, where the batter is stiff and practically solid, to temperatures of 100° F. or higher, where the batter is very runny. This is due to the water in the muffin batter, which is a primary ingredient in these compositions. Applicants further appreciate that the dramatic decrease in viscosity that conventional batters exhibit with increasing temperature is a significant problem in a retail setting (e.g., home use) since, from the point of purchase to the time it is baked, a pre-made retail muffin batter may experience a range of temperature fluctuations due to, for example, the customer removing the product from the store's refrigerated section to place the product in a shopping cart, transferring the product to the car (perhaps to a very hot car interior in warmer geographic areas), then returning the product to the customer's own freezer compartment of the refrigerator upon arriving home.

Applicants have further appreciated that batters that are non-flowable, meaning that they retain a substantial stiffness at or around ambient conditions, have advantages over conventional batters in several respects. For example, they are not as messy as batters that are poured or scooped, since spillage is eliminated. Also, non-flowable batters can be pre-formed at the point of manufacture into discrete, non-sticky pieces that maintain their shape. By contrast, when conventional muffin batters are exposed to temperature fluctuations of the kind described above (experienced in commercial retail settings), any pre-formed shape an individual muffin batter portion may have been given by the manufacturer is destroyed, since these types of batters become liquid-like at the higher temperatures. Finally, non-flowable batters can easily be packaged into individual serving sizes that are convenient for the consumer, since any portion not immediately used can be easily returned to the refrigerator for use later. However, Applicants have appreciated that it is not trivial to formulate a muffin batter to control its flow characteristics and therein substantially stabilize the batter to temperature fluctuations experienced in typical commercial retail settings.

Setting and thickening agents (in-particular hydrocolloids like carboxymethylcellulose, carageenan, and gelatin), and gums like xanthan gum and guar gum, have been previously used to stiffen and to thicken batters in order to control batter flow characteristics and to aid in the batter's freeze-thaw stability. However, a concern with batters stiffened and thickened to the point that they are stable to the temperature fluctuations experienced in typical commercial retail settings is that unsavory agents must be added in such high amounts that detrimental effects to the sweetness and flavor profiles for the corresponding baked food product occur as a result. Resultantly, it is difficult to achieve desirable organoleptic properties when using certain setting and thickening agents in the amounts needed to control batter flow characteristics over such a wide range of temperature fluctuations. Additionally, problems can arise that are associated with achieving the desired moisture, texture, appearance, volume, and symmetry profiles in a baked product when batter formulations are stiffened indiscriminately. In particular, certain setting and thickening agents give baked products a gummy texture and mouth-feel.

Therefore, a need exists for muffin batters having substantial stability to the temperature fluctuations experienced in commercial retail settings.

### SUMMARY

Described herein are new muffin batters and muffin mixes, which are chemically leavened, and which have substantial stability to temperature fluctuations experienced in a commercial retail setting (i.e., the viscosity must remain high enough that a frozen muffin puck in the bottom of a welled container will not flow enough to contact a lid on the welled container when rotated ninety degrees after being stored at 70° F. for one hour or perhaps two hours and/or after being stored at 120° F. for fifteen minutes).

The batters can be used to prepare muffin mixes and can be used for baking muffins that have desirable flavor profiles and desirable moisture, texture, appearance, volume, and symmetry of the finished baked product. To control the batter's flow characteristics while maintaining desired organoleptic attributes, unique formulas are proposed that, in certain embodiments, contain a flavorant mix, flour, sweetener, leavening agents, emulsifier agent, carageenan, and additional minor ingredients, in combination with water, oil, and eggs to form the muffin batter. In other embodiments, a muffin mix comprises the muffin batter plus a muffin topping. In still other embodiments, individual servings of pre-mixed muffin batter are portioned into one-muffin servings (e.g., in paper cups) and frozen into frozen muffin batter “pucks” (with or without paper cups) that are ready to be baked in an oven, e.g., packaged into a ready-to-bake tray or packaged in a package from which they are removed and baked in ordinary muffin baking pans. In still other embodiments, a method for forming the muffin batter is exemplified.

Specifically, an aspect of the present invention herein described is a muffin batter having substantial stability to temperature fluctuations experienced in a commercial retail setting comprising about 21-22% of a mixture comprising shredded carrots, raisins, bran or combinations thereof; about 20% water; about 16-17% of one or more types of flour; about 17-18% sweetener; about 12% liquid whole eggs about 9-10% oil; about 1.6-1.8% of a leavening system comprising one or more chemical leavening agents; about 0.0-0.5% emulsifier agent; and about 0.3-0.4% carrageenan. Individual servings of this muffin batter may be pre-mixed, portioned into one-muffin portions, and frozen into frozen muffin “pucks” that are ready to be baked in an oven.

Another aspect of the present invention herein described is a muffin batter having substantial stability to temperature fluctuations experienced in a commercial retail setting comprising about 12-13% of a mixture comprising dried apples, oatmeal flakes, or combinations thereof; about 21% water; about 22-23% of one or more types of flour; about 17-18% sweetener; about 12-13% liquid whole eggs about 9-10% oil; about 1.6-1.8% of a leavening system comprising one or more chemical leavening agents; about 0.0-0.5% emulsifier agent; and about 0.3-0.4% carrageenan. Individual servings of this muffin batter may be pre-mixed, portioned into one-muffin portions, and frozen into frozen muffin “pucks” that are ready to be baked in an oven.

Another aspect of the present invention herein described is a muffin batter having substantial stability to temperature fluctuations experienced in a commercial retail setting comprising about 9-10% of a mixture comprising chocolate chips, chocolate flakes, or combinations thereof; about 20-21% water; about 25-26% of one or more types of flour; about 19-20% sweetener; about 12-13% liquid whole eggs; about 9-10% oil; about 1.3-1.4% of a leavening system comprising one or more chemical leavening agents; about 0.0-0.5% emulsifier agents; and about 0.4% carrageenan. Individual servings of this muffin batter may be pre-mixed, portioned into one-muffin portions, and frozen into frozen muffin “pucks” that are ready to be baked in an oven.

Another aspect of the present invention herein described is a muffin batter having substantial stability to temperature fluctuations experienced in a commercial retail setting comprising from about 7.5% to about 22.5% of a flavorant mix; from about 19% to about 22% water; from about 15% to about 27% of one or more types of flour; from about 16.5% to about 21.0% sweetener; from about 10.5% to about 13.5% liquid whole eggs; from about 8.5% to about 10.5% oil; from about 1.2% to about 1.9% of a leavening system comprising one or more chemical leavening agents; from about 0.0% to about 1.5% emulsifier agent; and from about 0.2% to about 0.5% carrageenan. Individual servings of this muffin batter may be pre-mixed, portioned into one-muffin portions, and frozen into frozen muffin “pucks” that are ready to be baked in an oven.

Another aspect of the present invention herein described is a method for making a muffin batter having substantial stability to temperature fluctuations experienced in a commercial retail setting comprising (1) sufficiently blending from about 7.5% to about 22.5% of a flavorant mix; from about 15% to about 27% of one or more types of flour; from about 16.5% to about 21.0% sweetener; about 3% oil; from about 1.2% to about 1.9% of a leavening system comprising one or more chemical leavening agents; from about 0.0% to about 1.5% emulsifier agent; and from about 0.2% to about 0.5% carrageenan to form a dry mix; and (2) sufficiently blending the dry mix with from about 19% to about 22% water; from about 10.5% to about 13.5% liquid whole eggs; and from about 5.5% to about 7.5% oil to form the muffin batter. Individual servings of this muffin batter may be pre-mixed, portioned into one-muffin portions, and frozen into frozen muffin “pucks” that are ready to be baked in an oven.

### BRIEF DESCRIPTION OF THE DRAWINGS

FIG. 1 shows a muffin package.

FIG. 2 shows a close-up of an individual muffin batter serving, from the muffin package in FIG. 1.

### DETAILED DESCRIPTION

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations; the numerical values set forth in the specific examples are reported relatively precisely. Any numerical values, however, inherently contain certain errors necessarily resulting from error found in their respective measurements.

As used from hereon out a “non-flowable” muffin batter means a muffin batter that has a viscosity that remains high enough so that a frozen puck of the muffin batter placed in the bottom of a welled container will not flow enough to come into contact a lid on the welled container when rotated ninety degrees after being stored at 70° F. for one hour or perhaps two hours and/or after being stored at 120° F. for fifteen minutes.

### Muffin Batters, Mixes, and Packages

Regardless of the name of the final baked product, one of ordinary skill in the art will recognize that the stabilized muffin batters and mixes described herein are directed generally to batters and baked food products produced from the batters and, as such, may be used to produce baked food products including but not limited to, for example, biscuits, brownies, buns, cakes, cup-cakes, muffins, pancakes, scones, quick-breads or any other similar type of baked food products having similar characteristics, such as appearance, volume, texture, mouth-feel, sweetness, and symmetry to that of muffins. Therefore, it will be understood that the terminology used in describing the invention herein (i.e.: with specific references to muffin batters or muffin mixes) describes particular embodiments only and is not intended to be limiting of the invention.

Described herein are new muffin batters and mixes, which are chemically leavened, non-flowable at ambient temperatures, and which are substantially stable to temperature fluctuations experienced in commercial retail settings. (i.e., the viscosity must remain high enough that a frozen muffin puck in the bottom of a welled container will not flow enough to contact a lid on the welled container when rotated ninety degrees after being stored at 70° F. for one hour or perhaps two hours and/or after being stored at 120° F. for fifteen minutes). The muffin batters contain carrageenan, which is used in combination with other ingredients in the batter, so that the resulting batter is non-flowable at ambient temperatures and is substantially stabilized. Optionally, at least one additional texture agent can also be present to help substantially stabilize the resulting batter. Muffin batters also include a flavorant mix, one or more types of flour, sweetener, oil, a leavening system that containing one or more leavening agents, emulsifier agent, liquid whole eggs, and water. Additional ingredients may also be present to add color, flavor, texture, enrichment, and nutritional value and the batters may optionally contain any one or more of the following ingredients: artificial colors, artificial flavors; salt; spices; additional sweeteners including artificial sweeteners such as sugar alcohols and non-nutritive high intensity sweeteners; starches and celluloses such as for example cellulose powder and cellulose gums; dried egg white powder or wheat protein or other protein sources. Also, one or more emulsifiers may be present either as a separate ingredient or ingredients or as a constituent of the oil.

Some embodiments exemplify a muffin dry mixture, which may be combined with water, oil, and eggs prior to baking. Other embodiments exemplify a muffin batter having the muffin dry mixture already combined with water, oil, and eggs. Still other embodiments exemplify a muffin mix, which combines the muffin batter with a muffin topping. In still other embodiments, individual servings of muffin batter are portioned into individual servings (e.g., in paper cups) and frozen into frozen muffin batter “pucks” (with or without paper cups) that are ready to be baked in an oven, e.g., packaged into a ready-to-bake tray or packaged in a package from which they are removed and baked in ordinary muffin baking pans. Still other embodiments exemplify a package, in which individual servings of the muffin batter are contained in paper cups that are packed into a ready-to-microwave tray. Still other embodiments exemplify the finished muffin baked from the muffin batter. In embodiments exemplifying a muffin batter, these require few or no preparation steps before baking.

The muffin batters are substantially stable to temperature fluctuations experienced in a commercial retail setting, as described above. The muffin batters are non-flowable at ambient temperature, and the muffin batters remain substantially stable to temperature fluctuations spanning a range of from about freezing to temperatures of no more than 150° F. In certain embodiments, the muffin batters are non-flowable at ambient temperatures, and the muffin batters have substantial stability to temperature fluctuations spanning a range of from about 40° F. to about 70° F.

In other embodiments, the muffin batter is, for example, a non-flowable carrot-raisin-bran muffin batter having substantial stability to temperature fluctuations experienced in a commercial retail setting; and in specific examples, the carrot-raisin-bran muffin batter has substantial stability to temperature fluctuations spanning a range of from about 40° F. to about 70° F. In still other embodiments, the muffin batter is, for example, a non-flowable oatmeal muffin batter having substantial stability to temperature fluctuations experienced in a commercial retail setting; and in specific examples, the oatmeal muffin batter has substantial stability to temperature fluctuations spanning a range of from about 40° F. to about 70° F. In still other embodiments, the muffin batter is, for example, a non-flowable chocolate chip muffin batter having substantial stability to temperature fluctuations experienced in a commercial retail setting; and in specific examples, the chocolate chip muffin batter has substantial stability to temperature fluctuations spanning a range of from about 40° F. to about 70° F.

The muffin batters described above can be combined with a muffin topping to provide a muffin mix. After the muffin batter is baked and a muffin forms, the muffin topping is put on the top of the muffin. An exemplary embodiment of a muffin mix comprises any of the muffin batters herein described and a muffin topping. Any amount of muffin topping can be put on the top of the muffin. Typically, about 5-10 grams of topping are used for an individual muffin. In certain exemplary embodiments, about 6 grams of topping are used for an individual muffin.

In one exemplary embodiment of an oatmeal muffin topping, for example, the topping comprises about 37% sugar, from about 22% to about 29% flour, about 21-22% of rolled oats, from about 12% to about 18% shortening, and one or more additional ingredients selected from butter flavor and cinnamon spice. Individual servings of any of the muffin batters herein may be pre-mixed, portioned into one-muffin portions, and frozen into frozen muffin batter “pucks” topped with this topping that are ready to be baked in an oven. In certain examples, a specific muffin topping comprises about 37.00% sugar; from about 22.00% to about 28.10% flour; about 21.44% of rolled oats; from about 12.00% to about 18.00% shortening; and one or more additional ingredients selected from butter flavor and cinnamon spice. Individual servings of any of the muffin batters herein may be pre-mixed, portioned into one-muffin portions, and frozen into frozen muffin batter “pucks” topped with this topping that are ready to be baked in an oven.

In another exemplary embodiment of a chocolate chip muffin topping, for example, the topping comprises about 91-92% of one or more sweeteners and about 8-9% cocoa. In certain examples, a specific muffin topping comprises about 91.4% of one or more sweeteners and about 8.6% cocoa. Individual servings of any of the muffin batters herein may be pre-mixed, portioned into one-muffin portions, and frozen into frozen muffin “pucks” topped with this topping that are ready to be baked in an oven. Suitable sweeteners for use in the muffin topping include any sweetener, and in specific embodiments the sweeteners are selected from Turbinado sugar, Demerara sugar, molasses, or combinations thereof. One or more sweeteners can be used in the muffin toppings, and in specific embodiments the sweetener comprises about 45.5-46.0% sugar; and about 45.5-46.0% molasses.

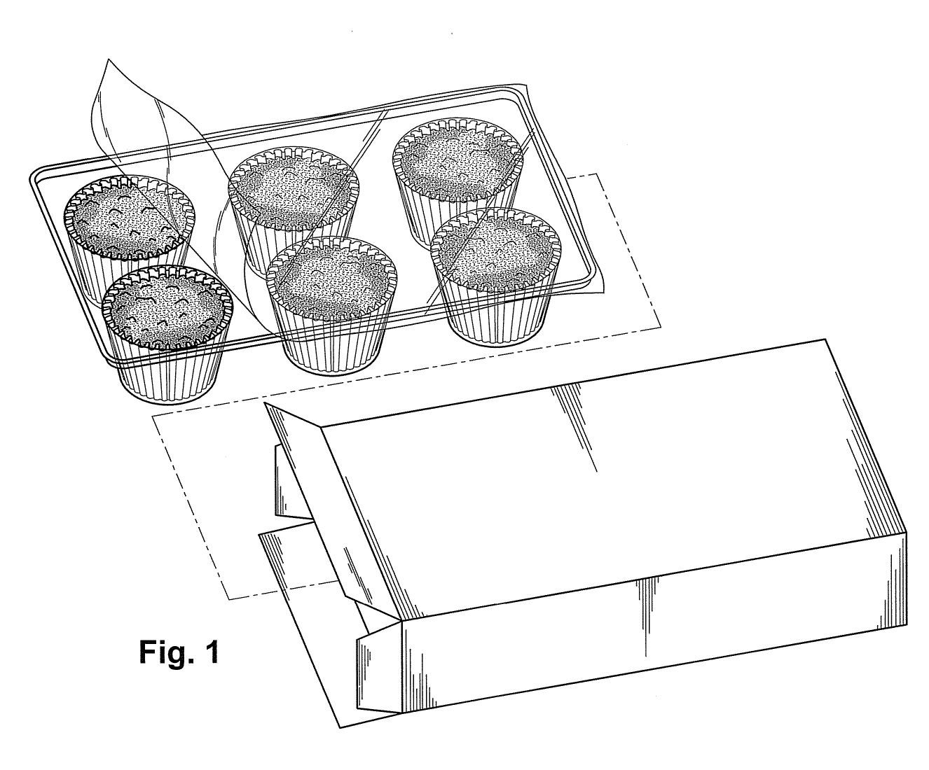

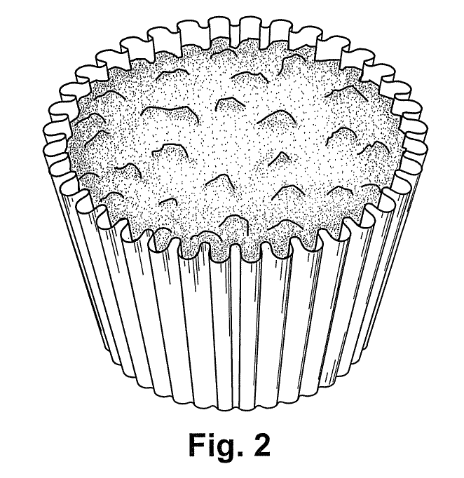

The muffin batters can be packaged, and FIG. 1 shows an example package in this regard. Likewise, FIG. 2 shows a close-up of an individual serving-sized portion of a muffin batter taken from the example package shown in FIG. 1. In certain exemplary embodiments, the package comprises a tray partitioned into a plurality of depressions and a paper cup containing an individual serving-sized portion of the muffin batter resides in each depression. As shown in FIGS. 1-2, the tray in this example package specifically is a rectangle, partitioned into 6 depressions: although it should be pointed out that other tray sizes, shapes, and number of partitions are contemplated. In each depression of the tray in this example package is placed a paper cup that contains an individual serving-sized portion of muffin batter, which may pre-mixed and frozen into a frozen muffin batter puck. As shown in FIGS. 1-2, for this example package the diameter of depression and of the paper cup containing the muffin batter is from about 2-3 inches: although it should be pointed out that other sizes and shapes are contemplated. An individual serving-sized portion of the muffin batter is from about 90 grams to about 110 grams.

Optionally, the tray containing the muffin batter is micro-wave durable and so the muffin package is ready-for-microwaving, and muffins can be produced and baked directly in the tray. In any event, the muffin package may be over-wrapped and sealed with plastic film. Since the flow characteristics of the muffin batter are controlled so the muffin batters are substantially stable to the temperature fluctuations experienced in commercial retail settings (i.e., the viscosity must remain high enough that a frozen muffin puck in the bottom of a welled container will not flow enough to contact a lid on the welled container when rotated ninety degrees after being stored at 70° F. for one hour or perhaps two hours and/or after being stored at 120° F. for fifteen minutes), there is no need to wrap the individual serving-sized muffin batter portions independently. Rather, the muffin batter portions are contained by the paper cup and do not flow sufficiently to come into direct contact with the tray or the cover. Any of the muffin batters herein described can be packaged in this manner.

The amounts of each of the ingredients discussed in the sections below are the ranges included in the muffin batter unless noted otherwise. All amounts are given in percentages, by weight.

### Flavorant Mix

The flavorant mix contains one or more different types of flavorants. As used herein, “flavorant” means a key constituent that characterizes the taste and the type of muffin obtained after balking. For example, a carrot-raisin muffin is made by baking a muffin batter containing both carrots and raisins as flavorants, while an oatmeal muffin is made by baking a muffin batter containing oatmeal as flavorant, while a chocolate chip muffin is made by baking a muffin batter containing chocolate chips as flavorant.

The flavorant mix may be included in a range from about 6% to about 28% (all percentages herein are weight percentages, unless otherwise noted), with any single flavorant included in a range from about 2% to about 11%. In some embodiments, the flavorant mix may be included in the batters in a range from about 16% to about 28%, with any single flavorant included in the batters in a range from about 5% to about 10%. In other embodiments, the flavorant mix may be included in a range from about 9% to about 16%, with any single flavorant included in a range from about 2% to about 11%. In still other embodiments, the flavorant mix may be included in a range from about 6% to about 12%, with any single flavorant included in a range of from about 3% to about 6%. The amount of flavorant mix used within a batter and the amount of any single flavorant used within the flavorant mix may also depend on the type and flavor of baked muffin product being produced.

Suitable flavorants include fruits, vegetables, fruits or vegetables that have been shredded, diced, sliced, chopped or minced. Suitable flavorants are also fruit-puree, vegetable-puree, fruit juice, vegetable juice, and the like. In certain embodiments, the flavorant mix is selected from the group of flavorants consisting of dried apples, raisins, shredded carrots, and combinations thereof. For example, one carrot-raisin-bran muffin batter embodiment has a flavorant mix that includes from about 7-9% shredded carrots (more preferably, about 8% or any of these amounts ±½% or any of these amounts ±1%) and from about 6-8% raisins (more preferably, about 7% or any of these amounts ±½% or any of these amounts ±1%) along with additional flavorants. In another example, one oatmeal muffin batter embodiment has a flavorant mix that includes from about 2-4% dried apples (more preferably, about 3% or any of these amounts ±½% or any of these amounts ±1%) along with additional flavorants.

Suitable flavorants also include any of the edible plant bran, plant fiber, cereal germs, and cereal grains, either alone or used in combination. Cereal germ and grains includes maize, rice, wheat, barley, sorghum, millet, oat, rye, triticale, buckwheat, fonino, and quinoa germs and grains. In certain embodiments, the flavorant mix is selected from the group of flavorants consisting of oat bran, rice bran, wheat bran, oatmeal flakes, rolled oats, and combinations thereof. For example, one carrot-raisin-bran muffin batter embodiment has a flavorant mix that includes from about 6-8% bran (more preferably, about 6-7% or any of these amounts ±½% or any of these amounts ±1%) along with additional flavorants. In another example, one oatmeal muffin batter embodiment has a flavorant mix that includes from about 8-10% oatmeal flakes (more preferably, about 9-10% or any of these amounts ±½% or any of these amounts ±1%) along with additional flavorants.

Suitable flavorants also include any confectionary bits, chips, flakes, inclusions, liquors, powders and the like. In certain embodiments, the flavorant mix is selected from the group of flavorants consisting of cocoa chips, cocoa flakes, cocoa powder, chocolate chips, chocolate flakes, chocolate morsels, and any combinations thereof. Any type of cocoa can be used, for example, Natural Cocoa, Dutch Cocoa, or combinations thereof. Likewise, any type of chocolate can be used, for example, dark chocolate, milk chocolate, or combinations thereof. For example, one chocolate chip muffin batter embodiment has a flavorant mix that includes from about 7-9% chocolate chips (more preferably, about 8% or any of these amounts ±½% or any of these amounts ±1%) and from about 6-8% chocolate flakes (more preferably, about 7% or any of these amounts ±½% or any of these amounts ±1%) along with additional flavorants.

### Flour

One or more types of flour can be used in the muffin batters described herein. The flour or flours used may be included in the range from about 15% to about 27% (all percentages herein are weight percentages, unless otherwise noted). In some embodiments the range is from about 15% to about 18%, while in other embodiments the range is from about 21% to about 24%, while in still other embodiments the range is from about 24% to about 27%. The amount of flour used may also depend on baked muffin product being produced. For example, when preparing a carrot-raisin-bran muffin batter, the amount of flour used may fall in the preferred range of about 15% to about 18% (e.g., about 16% or about 16%±½% or about 16%±1% or about 16%±2%), while when preparing a oatmeal muffin batter, the preferred range of flour may be from about 20% to about 24% (e.g., about 22% or about 22%±½% or about 22%±1% or about 22%±2%), while when preparing a chocolate chip muffin batter, the preferred range of flour may be from about 23% to about 27% (e.g., about 25% or about 25%±½% or about 25%±1% or about 25%±2%).

Chlorinated soft wheat flour (i.e. “white flour”) is commonly used in the muffin batters and can affect a variety of finished product attributes which includes moistness, tenderness, volume, cell structure. In exemplary embodiments, the flour used may be a chlorinated soft red winter bleached wheat flour. In other embodiments, the flour used may be hard wheat flour, chlorinated soft wheat flour, a combination of both hard and chlorinated soft wheat flours, a combination of hard wheat flour and chlorinated soft red winter bleached wheat flour, and so forth, and combinations thereof. In still other embodiments, the flour used may be a pre-gel corn flour, a combination of pre-gel corn flour and one or both hard and chlorinated soft wheat flours, and so forth. In certain exemplary embodiments, the pre-gel corn flour may be included in the range from about 0% to about 2%

The flour can also be enriched with a vitamin formulation (herein referred to as enrichment). A useful vitamin formulation for addition to the wheat flour is a blend of niacin, thiamin mononitrate, riboflavin, folic acid and reduced iron. In an exemplary embodiment, the addition of enrichment to a formulation adds to each pound of flour the following: about 2.65 mg of thiamin, about 1.80 mg of riboflavin, 21.0 mg of niacin, 17.0 mg of iron, and 0.70 mg of folic acid.

### Sweetener

Exemplary muffin batters and muffin mixes may comprise a sweetener, which may comprise sugar; a mixture of sugars, for example brown sugar and white or fine sugar; a mixture of sugars plus natural sweeteners, for example honey, molasses, sucrose, and dextrose; or any combination thereof. Turbinado and Demerara sugars can also be used. Turbinado sugar, also known as turbinated sugar or “Sugar in the Raw”, is a type of sugar cane extract made by steaming unrefined raw sugar. Turbinado sugar is similar in appearance to brown sugar but paler, and in general the two can be exchanged freely. Demerara sugar is a rich and creamy type of unrefined sugar with a large grain. Its color is pale to golden yellow and it comes from pressed sugar cane that is then steamed for the juice to form thick cane syrup. The syrup is dehydrated to form large golden brown crystals.

The sweetener may also, optionally, contain one or more artificial sweeteners, for example sugar alcohols. The sugar alcohol may be one or more sugar alcohols selected from the group consisting of maltitol, sorbitol, glycerin, isomalt, erythritol, mannitol, xylitol, lactitol, hydrogenated starch hydrosylates, tagatose, trehalose and combinations thereof. The sugar alcohol may also be selected from the group consisting of maltitol, sorbitol, and combinations thereof. In any of the exemplary muffin batters, the sweetener may also, optionally, further include a non-nutritional, high intensity sweetener. The high intensity non-nutritive sweetener may be selected from sucralose, aspartame, acesulfame potassium, saccharin, neotame, and combinations thereof.

The amount of sweetener used in the batters and mixes described herein may be adjusted depending on the particular kind of muffin, and this may vary with different formulations for similar kinds of muffins. The amount of sugar, natural sweeteners, sugar alcohols or non-nutritive, high intensity sweeteners used may also depend on the particular sugar, natural sweetener, sugar alcohol or non-nutritive, high intensity sweetener or combinations used.

In some embodiments, the sweetener of the muffin batters described herein may contain sugar. When sugar is used, it may be added at a level in the range from 11% to about 21% (wt); which includes the range from about 11% to about 19%, and the range from about 14% to about 21%, and the range from about 18% to about 21%. The amount of sugar added may be adjusted, along with the amount of any other natural or artificial sweetener used, depending on the particular muffin batter or muffin mix being prepared.

In some exemplary carrot-raisin-bran muffin batters, the amount of sugar added may be in the range from about 11% to about 19% (e.g., brown sugar at about 9-13% or about 11-12% or any of these amounts ±½% or any of these amounts ±1%; white or fine sugar at about 2-6% or about 3-4% or any of these amounts ±½% or any of these amounts ±1%). The sweetener in these exemplary carrot-raisin-bran muffin batters may also contain honey, at about 1-2%, and molasses powder at about 0-1%. In some exemplary oatmeal muffin batters, the amount of sugar added is in the range from about 14% to about 21% (e.g., brown sugar at about 6-9% or about 7-8% or any of these amounts ±½% or any of these amounts ±1%; white or fine sugar at about 8-13% or about 9-10% or any of these amounts ±½% or any of these amounts ±1%). In some exemplary chocolate chip batters, the amount of sugar added is in the range from about 18% to about 21% (e.g., white or fine sugar at about 18-21% or about 18-19% or any of these amounts ±½% or any of these amounts ±1%). The sweetener in these exemplary chocolate chip muffin batters may also contain dextrose, at about 0-2%.

In addition to sugar, part or the entire sweetener may be comprised of corn syrup or corn syrup solids, fructose, dextrose, lactose, maltose, high fructose corn syrup, inverted sugar, sucrose, other crystalline sweeteners, and combinations thereof. If sucrose is used, it may be blended with some starch, e.g., 98% sucrose may be blended with 2% corn starch (or another starch), before mixing into the muffin batter. Any suitable starch may be used. The blend may contain from about 95% to about 99% sucrose and from about 1% to about 5% starch, preferably from about 96% to about 98% sucrose and from about 4% to about 2% starch. In certain embodiments, the blend contains about 98% sugar and about 2% corn starch. In other embodiments, the blend contains about 96% sugar and about 4% corn starch.

### Oil

The oil is used in the muffin batters at a level of from about 6% to about 13% (wt) preferably in the range from about 8% to about 11%, and more preferably in the range from about 9% to about 10% (e.g. about 9.8% or, alternately, about 9.4% or, alternately, about 9.2%; or any of these values ±½% or any of these amounts ±1%). For specific embodiments of the various muffin batters, any of these exemplary values or amounts for the oil can vary by about ±½% or by about ±1%.

The oil may be a liquid oil or solid fat, or combinations thereof, and may be a vegetable fat or animal fat or combinations thereof. In certain exemplary embodiments, the oil is canola oil. In certain exemplary embodiments, the oil is a partially hydrogenated soybean oil. In other embodiments, the fat component is selected from such fats as palm oil, palm kernel oil coconut oil, sunflower oil, canola oil, butter, animal fats—lard and tallow, safflower oil, peanut oil, and combinations thereof. Trans-free fats, defined as having trans fat levels of less than 0.5 grams per serving may be used in the muffin batters described herein. In certain embodiments the oil may be present as the emulsified oil or fat or combinations thereof. These emulsified oils and fats are commonly referred to as shortening. For certain embodiments a suitable shortening contains partially hydrogenated soybean oil that is emulsified with propylene glycol monoesters, mono and di-glycerides, and polysorbate 60.

### Leavening System

The muffin batters contain from about 1.2% to about 1.9% of a leavening system comprising one or more chemical leavening agents. The chemical leavening agents in the leavening system may include a baling soda (i.e.: “soda), such as sodium, potassium, or ammonium bicarbonate, which is a source of carbon dioxide. The leavening system may also optionally contain a mixture of one or more baking acids. The mixture of baking acids may contain a first, slow reacting baling acid and a second fast reacting baking acid. In certain embodiments a mixture of baking acids are added and appropriately balanced to achieve preferred pHs or pH ranges, which are suitable for producing baked food products having desired appearances, flavor, texture, sweetness, and mouth-feel profiles. For example, a leavening system may contain one or more baking acids, one or more baking sodas, or alternatively may contain mixtures of at least one baking acid and at least one baking soda. Suitable baking sodas are carbonate and bicarbonate type chemical reagents and exemplary carbonate and bicarbonates include, but are not limited to sodium bicarbonate, ammonium bicarbonate, potassium bicarbonate, potassium carbonate. These are included in the baked food product mixes in the range from about 0.6% to about 0.8%, preferably in the range from about 0.6% to about 0.7%, or from about 0.7% to about 0.8% in the muffin batters described herein.

As stated, baluing acids may also optionally be included in the leavening system of the muffin batters described herein. In certain exemplary embodiments, dicalcium phosphate anhydrous is included in the muffin batters at a level from about 0.2% to about 0.4%. Likewise, in certain embodiments sodium aluminum phosphate (i.e.: “SALP”) is included in the muffin batters at a level from about 0.3% to about 0.8%, preferably in the range from about 0.4% to about 0.7%. The amount of SALP used may be adjusted depending on the particular type of baked food product or corresponding mix being prepared.

Other suitable baling acids that may optionally be used include, but are not limited to sodium acid pyrophosphate, diammonium hydrogen phosphate (anhydrous), monocalcium phosphate, monocalcium phosphate monohydrate, dimagnesium phosphate, adipic acid, fumaric acid, tartaric acid, cream of tartar, lactic acid, acetic acid, and combinations thereof. Other suitable leaving agents that may be used in place of SALP include, but are not limited to sodium acid pyrophosphate, diammonium hydrogen phosphate (anhydrous), dicalcium phosphate dihydrate, monocalcium phosphate monohydrate, dimagnesium phosphate, adipic acid, famaric acid, tartaric acid, cream of tartar, lactic acid, acetic acid and combinations thereof. In another exemplary embodiment, the muffin batters described herein include both dicalcium phosphate and SALP.

### Emulsifier Agent

The muffin batters described herein may also contain an emulsifier agent. Emulsifier agent may be included in the cake mixes of the present invention at a level of from about 0% to about 1% (wt), preferably in the range from about 0% to about 0.5%, more preferably in the range from about 0.4% to about 0.5%. In exemplary embodiments, the emulsifier agent used may be MYVATEX, supplied by Kerry Ingredients North America (Kerry Ingredients Inc., 100 East Grand Avenue, Beloit, Wisc., 53511, USA).

The muffin batters may also, optionally, contain additional emulsifiers to modify the properties of the batters and the textural properties of the finished muffin. In particular, mono- and diglyceride emulsifiers may be included at useful levels. Lecithin, distilled monoglycerides, diacetyl tartaric acid esters of monoglycerides (datem), acetic acid esters, sorbitan monostearate (sms), sorbitan tristearate (sts), and combinations thereof may be used along with or in place of the mono- and di-glyceride emulsifiers, in similar useful amounts.

For certain embodiments these emulsifiers are not added to the batters as a separate ingredient, but rather are supplied already mixed in with the oil as part of a shortening formulation, e.g., a commercially available shortening. For example, a shortening may be used in the compositions which contains partially hydrogenated soybean oil emulsified with propylene glycol monoesters and mono and di-glycerides. Optionally, other emulsifiers selected from polysorbate 60, polysorbate 80, sodium caseinate, sodium stearyl lactylate, and combinations thereof can additionally be included in the muffin batters. Optionally, other emulsifiers selected from propylene glycol monoesters (PGME), diacetyl, tartaric acid esters of monoglycerides (DATEM), and combinations thereof can additionally be included at various useful levels.

### Carageenan

Carrageenans are a family of linear sulphated polysaccharides extracted from red seaweeds. Carrageenans are made from large, highly flexible molecules which have the ability to form a variety of different gels at room temperature. They are widely used in foods as thickening and stabilizing agents. A particular advantage is that they are pseudo-plastic; thinning under shear stress but recovering viscosity once the stress is removed. There are three classes of carrageenan: Kappa, which is useful in forming strong, rigid gels; Iota, which is useful in forming soft gels; and Lambda, which is useful in forming gels when mixed with proteins. Any class of carageenan can be used in the muffin batters and preferably Iota-type carageenan is used in the compositions.

The use of carageenan in minor amounts in the muffin batter assists in controlling the flow characteristics of the muffin batter and assists in controlling the susceptibility of the muffin batter to temperature fluctuations typically experienced in commercial retail settings, while also maintaining favorable organoleptic properties and other desirable attributes in the final baked product. The effect is such that the muffin batters are non-flowable under ambient temperatures and the muffin batters are substantially stabilized to the temperature fluctuations experienced in commercial retail settings (i.e., the viscosity must remain high enough that a frozen muffin puck in the bottom of a welled container will not flow enough to contact a lid on the welled container when rotated ninety degrees after being stored at 70° F. for one hour or perhaps two hours and/or after being stored at 120° F. for fifteen minutes). In certain exemplary embodiments, the muffin batters are non-flowable under ambient temperatures, and the muffin batters have substantial stability to temperature fluctuations spanning a range of from around freezing to temperatures reaching 150° F. In other embodiments, the muffin batters are non-flowable at ambient temperatures, and the muffin batters have substantial stability to temperature fluctuations spanning a range of from about 40° F. to about 70° F.

Another embodiment is an exemplary non-flowable carrot-raisin-bran muffin batter having substantial stability to the temperature fluctuations experienced in commercial retail settings (and in specific examples, to temperature fluctuations spanning a range of from about 40° F. to about 70° F.). Still another embodiment is an exemplary non-flowable oatmeal muffin batter having substantial stability to the temperature fluctuations experienced in commercial retail settings (and in specific examples, to temperature fluctuations spanning a range of from about 40° F. to about 70° F.). In still another embodiment is an exemplary non-flowable chocolate chip muffin batter having substantial stability to the temperature fluctuations experienced in commercial retail settings (and in specific examples, to temperature fluctuations spanning a range of from about 40° F. to about 70° F.).

The carageenan may be included in the range from about 0.2% to about 0.5% (all percentages herein are weight percentages, unless otherwise noted). In some embodiments the range is from about 0.2% to about 0.3%, while in other embodiments the range is from about 0.3% to about 0.4%, while in still other embodiments the range is from about 0.4% to about 0.5%. The amount of carageenan used may also depend on baked muffin product being produced. For example, when preparing a carrot-raisin-bran muffin batter, the amount of carageenan used may fall in the preferred range of about 0.35% to about 0.4% (e.g., about 0.4% or about 0.4%±0.02% or about 0.4%±0.05%), while when preparing a oatmeal muffin batter, the preferred range of carageenan may be from about 0.3% to about 0.35% (e.g., about 0.3% or about 0.3%±0.2% or about 0.3%±0.4%), while when preparing a chocolate chip muffin batter, the preferred range of carageenan may be from about 0.4% to about 0.45% (e.g., about 0.4% or about 0.4%±0.01% or about 0.4%±0.02%).

### Additional Texture Agents

The muffin batters described herein may also contain additional texture agents to assist in modifying the viscosity properties of the batters and the textural properties of the finished muffins. Additional texture agents contemplated as useful in this regard include, xanthan gum, agar, guar gum, locust bean gum, tragacanth, karaya, hydroxypropylcellulose, methylcellulose, pectin, alginates, and combinations thereof may be added at levels from 0 to about 1% (wt), preferably in the range from about 0.0% to about 0.5%, and more preferably in the range from about 0.0% to about 0.1%. Additionally, cellulose powder, inulin, and combinations thereof may be added at levels from 0 to about 1% (wt), preferably in the range from about 0.0% to about 0.5%, and more preferably in the range from about 0.0% to about 0.1%. In addition, cellulose gum (sodium carboxymethyl cellulose), agar, guar gum, locust bean gum, tragacanth, karaya, hydroxypropylcellulose, methylcellulose, pectin, alginates and combinations thereof may be added at levels from 0 to about 1%, preferably in the range from about 0.0% to about 0.5%, and more preferably in the range from about 0.0% to about 0.1%.

### Additional Ingredients

Salt, spices, artificial flavors, and artificial colors may be added in a flavor-enhancing and/or color enhancing amount. The amount of each of these to be added will depend on the particular type of ingredient and can readily be determined by one of ordinary skill in the art. In exemplary embodiments for a carrot-raisin-bran muffin, salt is added at a level of from about 0.4-0.5%, allspice is added at a level of from about 0.05-0.07%, caramel color is added at a level of from about 0.07-0.09%, cinnamon spice is added at a level of from about 0.3-0.4%, nutmeg is added at a level of from about 0.2-0.3%, and vanilla flavor is added at a level of from about 0.01-0.03%. In exemplary embodiments for an oatmeal muffin, salt is added at a level of from about 0.4-0.6%, butter flavor is added at a level of from about 0.05-0.07%, buttermilk is added at a level of from about 0.6-0.7%, caramel color is added at a level of from about 0.04-0.06%, cinnamon spice is added at a level of from about 0.6-0.7%, nutmeg is added at a level of from about 0.2-0.3%, and oatmeal flavor is added at a level of from about 0.1-0.2%. In exemplary embodiments for a chocolate chip muffm, salt is added at a level of from about 0.5-0.7%, butter flavor is added at a level of from about 0.08-0.10%, buttermilk powder is added at a level of from about 0.1-0.2%, and egg shade color is added at a level of from about 0.01-0.03%.

Other flavor ingredients known to those skilled in the art that may be used in quantities such as to provide the desired flavor. These include, but are not limited to natural and artificial fruit flavors, such as strawberry, banana, lemon, pineapple, raspberry, lime, key lime, orange, mango, papaya, and so forth, chocolate, dark chocolate, German chocolate, vanilla, French vanilla, butter, spice, cinnamon, and so forth.

The muffin batters described herein may, optionally, include a starch. The amount of starch used may be adjusted depending on the muffin batter or muffin being prepared. The starches that may be used include, but are not limited to, modified starch, pre-gelatinized wheat starch, corn starch, potato starch, rice starch, tapioca starch, and combinations thereof. In exemplary embodiments, the starch used is pre-gelatinized wheat starch. In other exemplary embodiments, the starch used is modified wheat starch which is not pre-gelatinized.

The muffin batters described herein may optionally include a protein source, such as dried egg white powder. In addition to, or in place of, dried egg white powder, other proteins, including but not limited to, wheat gluten, albumen, milk protein, soy protein (isolate, concentrate and modified), legume protein, wheat protein isolate, and combinations thereof, may be added in similar amounts.

### Methods

A two step method for making a muffin batter having substantial stability to temperature fluctuations experienced in a commercial retail setting comprises (1) sufficiently blending from about 7.5% to about 22.5% of a flavorant mix; from about 15% to about 27% of one or more types of flour; from about 16.5% to about 21.0% sweetener; about 3% oil; from about 1.2% to about 1.9% of a leavening system comprising one or more chemical leavening agents; from about 0.0% to about 1.5% of emulsifier agent; and from about 0.2% to about 0.5% carrageenan to form a dry mix; and (2) sufficiently blending the dry mix with from about 19% to about 22% water; from about 10.5% to about 13.5% liquid whole eggs; and from about 5.5% to about 7.5% oil to form the muffin batter. In certain embodiments the muffin batter is substantially stable to temperature fluctuations spanning a range from about 40° F. to about 70° F.

In the first step, sufficiently blending the flavorant mix, the one or more types of flour, the from about 16.5% to about 21.0% sweetener, the from about 2.9% to about 3.1% oil, the from about 1.25% to about 1.85% of a leavening system comprising one or more chemical leavening agents, the from about 0.0% to about 1.5% of emulsifier agent, and the from about 0.2% to about 0.5% carrageenan to form a dry mix is achieved by blending the ingredients together using a commercially available mechanical mixer. Suitable blending times and speeds are those needed to sufficiently blend and homogenate the ingredients together, which include, for example, about 1-30 seconds on medium speed. In the second step, sufficiently blending the dry mix with the from about 19% to about 22% water, the from about 10.5% to about 13.5% liquid whole eggs, and the from about 5.5% to about 7.5% oil to form the muffin batter is achieved by blending the dry mix, water, eggs, and oil together using a commercially available mechanical mixer. Suitable blending times and speeds are those needed to sufficiently blend and homogenate the ingredients together, which include, for example, about 30-60 seconds on medium speed.

In one embodiment, a carrot-raisin-bran muffin batter is prepared by adding the shredded carrots, raisins, bran, sweetener, leavening system, emulsifier agent, carageenan, and the remainder of the dry ingredients to a mixer, which is blended for 20 seconds at medium speed. Then, the liquid whole eggs, water, and oil are added and this is blended for an additional 35 seconds at medium speed. A carrot-raisin-bran muffin batter results.

In another embodiment, an oatmeal muffin batter is prepared by first adding the dried apples to a bin along with a portion of the water and letting this soak for 30 minutes. The apples in water are then added to a mixer in combination with oatmeal flakes, sweetener, leavening system, emulsifier agent, carageenan, and the remainder of the dry ingredients. This is blended for 20 seconds at medium speed. Then, the liquid whole eggs, the remainder of the water, and oil are added and this is blended for an additional 35 seconds at medium speed. An oatmeal muffm batter results.

In another embodiment, a chocolate chip muffin batter is prepared by adding the chocolate chips, chocolate flakes, sweetener, leavening system, emulsifier agent, carageenan, and the remainder of the dry ingredients to a mixer, which is blended for 20 seconds at medium speed. Then, the liquid whole eggs, water, and oil are added and this is blended for an additional 35 seconds at medium speed. A chocolate chip muffin batter results.

TABLE 1
Exemplary Stable Carrot-Raisin-Bran Muffin Batters

| Exemplary Carrot-Raisin- | | | | | |
|---|---|---|---|---|---|
| Bran Muffin Batter | A-1 | B-1 | C-1 | D-1 | E-1 |
| Flavorant Mixture | 21.18% | 21-22% | 20-23% | 19-25% | 16-28% |
| (Shredded carrots) | (8.00%) | (8%) | (8-9%) | (7-9%) | (6-10%) |
| (Raisins) | (6.83%) | (6-7%) | (6-7%) | (6-8%) | (5-9%) |
| (Bran) | (6.35%) | (6-7%) | (6-7%) | (6-8%) | (5-9%) |
| Sweetener | 17.26% | 17-18% | 16-19% | 15-20% | 12-22% |
| (Lt. Brown Sugar) | (11.04%) | (11%) | (11-12%) | (10-12%) | (9-13%) |
| (Sugar) | (3.75%) | (4%) | (3-4%) | (3-5%) | (2-6%) |
| (Honey) | (1.85%) | (1-2%) | (1-2%) | (1-2%) | (1-2%) |
| (Molasses Powder) | (0.62%) | (1%) | (1%) | (1%) | (0-1%) |
| Flour | 16.23% | 16-17% | 15-18% | 14-19% | 13-20% |
| Leavening System | 1.77% | 1.6-1.8% | 1.6-1.8% | 1.6-1.8% | 1.6-1.8% |
| (Soda) | (0.80%) | (0.8%) | (0.8%) | (0.8%) | (0.8%) |
| (Dicalcium Phosphate) | (0.29%) | (0.2-0.3%) | (0.2-0.3%) | (0.2-0.3%) | (0.2-0.3%) |
| (SALP) | (0.68%) | (0.6-0.7%) | (0.6-0.7%) | (0.6-0.7%) | (0.6-0.7%) |
| Emulsifier Agent | 0.43% | 0.0-0.5% | 0.0-0.5% | 0.0-1.0% | 0.0-1.0% |
| Carageenan | 0.38% | 0.3-0.4% | 0.3-0.4% | 0.2-0.5% | 0.2-0.5% |
| Water | 20.00% | 20% | 19-21% | 18-22% | 17-23% |
| Liquid Whole Eggs | 12.00% | 12% | 11-13% | 10-14% | 9-15% |
| Oil | 9.42% | 9-10% | 8-11% | 7-12% | 6-13% |

Plus, perhaps, any one or more of the following ingredients such as additional flavorants, colorants, enrichment and other nutritional agents, cellulose and additional texturizing agents, and/or additional emulsifiers (in any of the amounts discussed herein). Additionally, any of the above ingredient amounts may be increased or reduced as ±½% or ±1% or ±2%.

TABLE 2
Exemplary Stable Oatmeal Muffin Batters

| Exemplary Oatmeal Muffin Batter | A-2 | B-2 | C-2 | D-2 | E-2 |
|---|---|---|---|---|---|
| Flavorant Mixture | 12.26% | 12-13% | 11-14% | 10-15% | 9-16% |
| (Dried Apples) | (3.00%) | (3%) | (3-4%) | (2-4%) | (2-5%) |
| (Oatmeal Flakes) | (9.27%) | (9-10%) | (8-10%) | (8-11%) | (8-11%) |
| Sweetener | 17.17% | 17-18% | 16-19% | 15-20% | 14-22% |
| (Lt. Brown Sugar) | (7.28%) | (7-8%) | (7-8%) | (6-8%) | (6-9%) |
| (Sugar) | (9.89%) | (10%) | (9-11%) | (9-12%) | (8-13%) |
| Flour | 22.49% | 22-23% | 21-24% | 20-25% | 19-26% |
| Leavening System | 1.71% | 1.6-1.8% | 1.6-1.8% | 1.6-1.8% | 1.6-1.8% |
| (Soda) | (0.74%) | (0.7-0.8%) | (0.7-0.8%) | (0.7-0.8%) | (0.7-0.8%) |
| (Dicalcium Phosphate) | (0.35%) | (0.3-0.4%) | (0.3-0.4%) | (0.2-0.3%) | (0.2-0.3%) |
| (SALP) | (0.62%) | (0.6%) | (0.6%) | (0.6%) | (0.6%) |
| Emulsifier Agent | 0.43% | 0.0-0.5% | 0.0-0.5% | 0.0-1.0% | 0.0-1.0% |
| Carageenan | 0.34% | 0.3-0.4% | 0.3-0.4% | 0.2-0.5% | 0.2-0.5% |
| Water | 21.00% | 21% | 20-22% | 19-23% | 18-24% |
| Liquid Whole Eggs | 12.50% | 12-13% | 11-14% | 10-15% | 10-15% |
| Oil | 9.76% | 9-10% | 8-11% | 7-12% | 6-13% |

Plus, perhaps, any one or more of the following ingredients such as additional flavorants, colorants, enrichment and other nutritional agents, cellulose and additional texturizing agents, and/or additional emulsifiers (in any of the amounts discussed herein). Additionally, any of the above ingredient amounts may be increased or reduced as ±½% or ±1% or ±2%.

TABLE 3
Exemplary Oatmeal Muffin Toppings

| Oatmeal Muffin Topping | A-2a | B-2a | C-2a | D-2a | E-2a |
|---|---|---|---|---|---|
| Rolled Oats | 21.44% | 21-22% | 21.44% | 21-22% | 21-22% |
| Sugar | 37.00% | 36-38% | 37.00% | 36-38% | 16-23% |
| Flour | 22.06% | 22-23% | 28.06% | 28-29% | 22-29% |
| Shortening | 18.00% | 17-19% | 12.00% | 11-13% | 11-19% |

Plus, perhaps, any one or more of additional flavorants and colorants. Additionally, any of the above ingredient amounts may be increased or reduced as ±½% or ±1% or ±2%.

TABLE 4
Exemplary Stable Chocolate Chip Muffin Batters

| Exemplary Chocolate Chip | | | | | |
|---|---|---|---|---|---|
| Muffin Batter | A-3 | B-3 | C-3 | D-3 | E-3 |
| Flavorant Mixture | 9.34% | 8-10% | 7-11% | 6-12% | 6-12% |
| (Chocolate Chips) | (4.67%) | (4-5%) | (4-5%) | (3-6%) | (3-6%) |
| (Chocolate Flakes) | (4.67%) | (4-5%) | (3-6%) | (3-6%) | (3-6%) |
| Sweetener | 19.46% | 19-20% | 18-21% | 17-22% | 16-23% |
| (Sugar) | (18.95%) | (19%) | (18-19%) | (18-20%) | (18-21%) |
| (Dextrose) | (0.51%) | (0.0-1.0%) | (0.0-1.0%) | (0.0-2.0%) | (0.0-2.0%) |
| Flour | 25.54% | 25-26% | 24-27% | 23-28% | 22-29% |
| (White Flour) | (24.94%) | (25%) | (24-26%) | (23-26%) | (23-27%) |
| (Pre-Gel Corn Flour) | (0.60%) | (0.0-1.0%) | (0.0-1.0%) | (0.0-2.0%) | (0.0-2.0%) |
| Leavening System | 1.39% | 1.4% | 1.3-1.4% | 1.3-1.4% | 1.3-1.4% |
| (Soda) | (0.60%) | (0.6%) | (0.6%) | (0.6%) | (0.6%) |
| (Dicalcium Phosphate) | (0.31%) | (0.3%) | (0.2-0.3%) | (0.2-0.3%) | (0.2-0.3%) |
| (SALP) | (0.48%) | (0.5%) | (0.5%) | (0.5%) | (0.5%) |
| Emulsifier Agent | 0.42% | 0.0-0.5% | 0.0-0.5% | 0.0-1.0% | 0.0-1.0% |
| Carageenan | 0.41% | 0.4-0.5% | 0.4-0.5% | 0.3-0.5% | 0.3-0.5% |
| Water | 20.83% | 20-21% | 19-22% | 18-23% | 17-24% |
| Liquid Whole Eggs | 12.33% | 12-13% | 11-14% | 10-15% | 10-15% |
| Oil | 9.15% | 9% | 9-10% | 8-11% | 7-12% |

Plus, perhaps, any one or more of the following ingredients such as additional flavorants, colorants, enrichment and other nutritional agents, cellulose and additional texturizing agents, and/or additional emulsifiers (in any of the amounts discussed herein). Additionally, any of the above ingredient amounts may be increased or reduced as ±½% or ±1% or ±2%.

TABLE 5
Exemplary Chocolate Chip Muffin Toppings

| Chocolate | | | | | |
|---|---|---|---|---|---|
| Chip Muffin | | | | | |
| Topping | A-3a | B-3a | C-3a | D-3a | E-3a |
| Sweetener | 91.38% | 91-92% | 90-93% | 90-92% | 88-94% |
| (Sugar) | (45.69%) | (91-92%) | (90-93%) | (45-46%) | (44-47%) |
| (Molasses) | (45.69%) | (0%) | (0%) | (45-46%) | (44-47%) |
| Cocoa | 8.63% | 8-9% | 7-10% | 8-10% | 6-12% |

Plus, perhaps, any one or more of additional flavorants and colorants. Additionally, any of the above ingredient amounts may be increased or reduced as ±½% or ±1% or ±2%.

### EXAMPLES

For all the examples provided below, the following procedures were used to evaluate the products.

Muffin Batters: All example muffin batters were prepared in a manner identical with the following preparation method. The flavorant mixture is thoroughly blended in a commercial mixer at a medium setting with the dry ingredients (including sweetener, flour, leavening system, emulsifier agent, carageenan, and other minor ingredients). The water, oil and liquid whole eggs are then added and additionally blended at a medium setting until the resulting batter is free from lumps. Tables below express selected ingredients of exemplary muffin batters.

Muffin Toppings: All oatmeal muffin toppings were prepared in a manner identical with the following preparation method described. All the ingredients (including sugar, flour, shortening, and other minor ingredients) are added to a commercial mixer and blending for three minutes on low. During the first two minutes, the shortening is slowly cut into the mixture using the lowest blending setting. After all the shortening is added, the mixture is blended for another 2-3 minutes at low speed. The rolled oats are then added and the mixture is blended for an additional minute.

Viscosity Measurements: The viscosity of the muffin batters was determined at two different temperatures, about 40° F. and about 70° F., and the results are provided in the following tables. The procedure for measuring viscosity followed a standard method generally applicable to batters and known to those of ordinary skill in the art. A standard Brookfield Viscometer Model HAT Viscosity was utilized to conduct the viscosity measurements.

Baked Muffins: All example muffin batters were baked in a manner identical with the following preparation method described. Approximately 100 grams of muffin batter were placed in a pan and baked for 25 minutes in an oven set at 400° F. The baked muffins were cooled for 5 minutes in the pan and then removed and placed on a cooling rack. When the muffin was completely cooled its appearance, flavor, texture, and volume were recorded using standard techniques known to those of ordinary skill in the art.

### Example 1

### Carrot-Raisin-Bran Muffin Batter and Baked Muffin

An exemplary carrot-raisin-bran muffin batter is formed using the method outlined above, by combining together the ingredients listed in a given formulation as provided in Table 6. One exemplary formulation is listed below.

TABLE 6
Ingredient List for Example Carrot-Raisin-Bran Muffin Batter

| Ingredient | % Finished Batter |
|---|---|
| Flavorant Mix | 21.18 |
| (Shredded Carrots) | (8.00) |
| (Raisins) | (6.83) |
| (Bran) | (6.35) |
| Sweetener | 17.26 |
| (Sugar) | (3.75) |
| (Brown Sugar) | (11.04) |
| (Honey) | (1.85) |
| (Molasses) | (0.62) |
| Flour | 16.23 |
| Leavening System | 1.77 |
| (Soda) | (0.80) |
| (Dicalcium Phosphate) | (0.29) |
| (SALP) | (0.68) |
| Carageenan | 0.38 |
| MYVATEX (Emulsifier Agent) | 0.43 |
| Additional Ingredients | 1.33 |
| (Salt) | (0.44) |
| (Artificial Vanilla) | (0.02) |
| (Yellow - Natural Beta Carateen) | (0.06) |
| (Caramel Color) | (0.08) |
| Cinnamon Spice) | (0.37) |
| (Nutmeg) | (0.25) |
| (Allspice) | (0.06) |
| (Xanthan) | (0.05) |
| Liquid Eggs | 12.00 |
| Canola Oil | 9.42 |
| Water | 20.00 |
| Total | 100 |

TABLE 7
Viscosity Data for Example Carrot-Raisin-Bran Muffin Batter (Example 1)

| | Viscosity at 40° F. | Viscosity at 70° F. |
|---|---|---|
| Run | (centipoises) | (centipoises) |
| (a) | 187,000 | 84,000 |
| (b) | 172,000 | 77,000 |
| (c) | 130,000 | 91,000 |
| (d) | 132,000 | 71,000 |
| (e) | 158,000 | 69,000 |
| (f) | 129,000 | 94,000 |
| Average: | 151,333 | 81,000 |

TABLE 8
Evaluation of Example Baked Carrot-Raisin-Bran Muffin (Example 1)

| Appearance | Flavor | Texture | Volume | |
|---|---|---|---|---|
| Darker brown crust | Carrot Raisin | Moist, tender | Min: | 49 cm |
| and crumb | Bran | crumb | Max: | 59 cm |
| | | | Target: | 54 cm |

### Example 2

### Oatmeal Muffin Batter and Baked Muffin

An exemplary oatmeal muffin batter is formed using the method outlined above, by combining together the ingredients listed in a given formulation as provided in Table 9. One exemplary formulation is listed below.

TABLE 9
Ingredient List for Example Oatmeal Muffin Batter

| Ingredient | % Finished Batter |
|---|---|
| Flavorant Mix | 12.26 |
| (Dried Apples) | (3.00) |
| (Quick Oats) | (9.26) |
| Sweetener | 17.17 |
| (Sugar) | (9.89) |
| (Brown Sugar) | (7.28) |
| Flour | 22.49 |
| Leavening System | 1.71 |
| (Soda) | (0.74) |
| (Dicalcium Phosphate) | (0.35) |
| (SALP) | (0.62) |
| Carageenan | 0.34 |
| MYVATEX (Emulsifier Agent) | 0.43 |
| Additional Ingredients | 2.34 |
| (Salt) | (0.49) |
| (Oatmeal Flavor) | (0.16) |
| (Buttermilk) | (0.62) |
| (Caramel Color) | (0.05) |
| (Cinnamon Spice) | (0.62) |
| (Nutmeg) | (0.25) |
| (Natural Butter Flavor) | (0.09) |
| (Xanthan) | (0.06) |
| Liquid Eggs | 12.50 |
| Canola Oil | 9.76 |
| Water | 21.00 |
| Total | 100 |

TABLE 10
Viscosity Data for Example Oatmeal Muffin Batter (Example 2)

| | Viscosity at 40° F. | Viscosity at 70° F. |
|---|---|---|
| Run | (centipoises) | (centipoises) |
| (a) | 134,000 | 93,000 |
| (b) | 160,000 | 144,000 |
| (c) | 175,000 | 134,000 |
| (d) | 181,000 | 125,000 |
| (e) | 198,000 | 120,000 |
| (f) | 200,000 | 93,000 |
| Average: | 174,667 | 118,167 |

TABLE 11
Evaluation of Example Baked Oatmeal Muffin (Example 2)

| Appearance | Flavor | Texture | Volume | |
|---|---|---|---|---|
| Golden brown crust | Oatmeal | Moist, tender crumb | Min: | 59 cm |
| and light tan crumb | Apple | | Max: | 69 cm |
| | | | Target: | 64 cm |

TABLE 12
Ingredient List for Exemplary Oatmeal Muffin Topping (Example 2-a)

| Ingredient | % Mix |
|---|---|
| Sugar (Golden Yellow) | 37.00 |
| Flour | 28.06 |
| Rolled Oats | 21.44 |
| Shortening | 12.00 |
| Additional Ingredients | 1.50 |
| (Cinnamon Spice) | (1.35) |
| (Natural Butter Flavor) | (0.15) |
| Total | 100 |

TABLE 13
Ingredient List for Example Oatmeal Muffin Topping (Example 2-b)

| Ingredient | % Mix |
|---|---|
| Sugar (Brown) | 37.00 |
| Flour | 22.06 |
| Rolled Oats | 21.44 |
| Shortening | 18.00 |
| Additional Ingredients | 1.50 |
| (Cinnamon Spice) | (1.35) |
| (Natural Butter Flavor) | (0.15) |
| Total | 100 |

### Example 3

### Chocolate Chip Muffin Batter and Baked Muffin

An exemplary chocolate chip batter is formed using the method outlined above, by combining together the ingredients listed in a given formulation as provided in Table 14. One exemplary formulation is listed below.

TABLE 14
Ingredient List for Example Chocolate Chip Muffin Batter

| Ingredient | % Finished Batter |
|---|---|
| Flavorant Mix | 9.34 |
| (Chocolate Chips) | (4.67) |
| (Chocolate Flakes) | (4.67) |
| Sweetener | 19.46 |
| (Sugar) | (18.95) |
| (Dextrose) | (0.51) |
| Flour | 25.54 |
| (White Flour) | (24.94) |
| (Pre-gel Corn Flour) | (0.60) |
| Leavening System | 1.39 |
| (Soda) | (0.60) |
| (Dicalcium Phosphate) | (0.31) |
| (SALP) | (0.48) |
| Carageenan | 0.41 |
| MYVATEX (Emulsifier Agent) | 0.42 |
| Additional Ingredients | 1.13 |
| (Salt) | (0.58) |
| (Vanilla Flavor) | (0.18) |
| (Buttermilk Powder) | (0.17) |
| (Egg Shade Color) | (0.02) |
| (Natural Butter Flavor) | (0.09) |
| (Xanthan) | (0.09) |
| Liquid Eggs | 12.33 |
| Canola Oil | 9.15 |
| Water | 20.83 |
| Total | 100 |

TABLE 15
Viscosity Data for Example Chocolate Chip Muffin Batter (Example 3)

| | Viscosity at 40° F. | Viscosity at 70° F. |
|---|---|---|
| Run | (centipoises) | (centipoises) |
| (a) | 160,000 | 62,000 |
| (b) | 167,000 | 48,000 |
| (c) | 124,000 | 47,000 |
| (d) | 131,000 | 62,000 |
| (e) | 90,000 | 50,000 |
| (f) | 162,000 | 43,000 |
| Average: | 139,000 | 52,000 |

TABLE 16
Evaluation of Example Baked Chocolate Chip Muffin (Example 3)

| Appearance | Flavor | Texture | Volume | |
|---|---|---|---|---|
| Darker brown topping | Chocolate Chip | Moist, | Min: | 59 cm |
| and light tan crumb | | tender crumb | Max: | 69 cm |
| | | | Target: | 64 cm |

TABLE 17
Ingredient List for Example Chocolate Chip Muffin Topping
(Example 3-a)

| Ingredient | % Mix |
|---|---|
| Sugar | 45.685 |
| Molasses Granules | 45.685 |
| Cocoa | 8.63 |
| Total | 100 |

TABLE 18
Ingredient List for Example Chocolate Chip Muffin Topping
(Example 3-b)

| Ingredient | % Mix |
|---|---|
| Sugar (Turbinado) | 45.685 |
| Sugar (Demera) | 45.685 |
| Cocoa | 8.63 |
| Total | 100 |

The invention claimed is:

1. A muffin batter having substantial stability to temperature fluctuations experienced in a commercial retail setting comprising:
a. about 21-22% of a mixture comprising shredded carrots, raisins, bran or combinations thereof;
b. about 20% water;
c. about 16-17% of one or more types of flour;
d. about 17-18% sweetener;
e. about 12% liquid whole eggs
f. about 9-10% oil;
g. about 1.6-1.8% of a leavening system comprising one or more chemical leavening agents;
h. about 0.0-0.5% of emulsifier agent; and
i. about 0.3-0.4% carrageenan.

2. The muffin batter of claim 1, further comprising one or more additional ingredients selected from allspice, caramel color, cinnamon spice, nutmeg, salt, vanilla flavor, and xanthan gum, and
wherein
a. the about 21-22% of a mixture comprising shredded carrots, raisins, bran or combinations thereof comprises:
i. about 8% shredded carrots;
ii. about 6-7% raisins; and
iii. about 6-7% bran;
b. the about 17-18% sweetener comprises:
i. about 11% brown sugar;
ii. about 3-4% sugar;
iii. about 1-2% honey; and
iv. about 0.6% molasses powder;
c. the about 1.6-1.8% of a leavening system comprising one or more chemical leavening agents comprises:
i. about 0.8% soda;
ii. about 0.3% dicalcium phosphate; and
iii. about 0.7% SALP; and
d. the emulsifier agent is a MYVATEX brand emulsifier blend.

3. A muffin batter having substantial stability to temperature fluctuations experienced in a commercial retail setting comprising:
a. about 12-13% of a mixture comprising dried apples, oatmeal flakes, or combinations thereof;
b. about 21% water;
c. about 22-23% of one or more types of flour;
d. about 17-18% sweetener;
e. about 12-13% liquid whole eggs
f. about 9-10% oil;
g. about 1.6-1.8% of a leavening system comprising one or more chemical leavening agents;
h. about 0.0-0.5% of emulsifier agent; and
i. about 0.3-0.4% carrageenan.

4. The muffin batter of claim 3, further comprising one or more additional ingredients selected from butter flavor, buttermilk, caramel color, cinnamon spice, nutmeg, oatmeal flavor, salt, and xanthan gum, and
wherein
a. the about 12-13% of a mixture comprising dried apples, oatmeal flakes, or combinations thereof comprises:
i. about 3% dried apples; and
ii. about 9-10% oatmeal flakes
b. the about 17-18% sweetener comprises:
i. about 7-8% brown sugar; and
ii. about 9-10% sugar;
c. the about 1.6-1.8% of a leavening system comprising one or more chemical leavening agents comprises:
i. about 0.7-0.8% soda;
ii. about 0.3-0.4% dicalcium phosphate; and
iii. about 0.6% SALP; and
d. the emulsifier agent is a MYVATEX brand emulsifier blend.

5. A muffin batter having substantial stability to temperature fluctuations experienced in a commercial retail setting comprising:
a. about 9-10% of a mixture comprising chocolate chips, chocolate flakes, or combinations thereof;
b. about 20-21% water;
c. about 25-26% of one or more types of flour;
d. about 19-20% sweetener;
e. about 12-13% liquid whole eggs
f. about 9-10% oil;
g. about 1.3-1.4% of a leavening system comprising one or more chemical leavening agents;
h. about 0.0-0.5% of emulsifier agent; and
i. about 0.4% carrageenan.

6. The muffin batter of claim 5, further comprising one or more additional ingredients selected from butter flavor, buttermilk powder, egg shade color, salt, and xanthan gum, and
wherein
a. the about 9-10% of a mixture comprising chocolate chips, chocolate flakes, or combinations thereof comprises:
i. about 4-5% chocolate chips; and
ii. about 4-5% chocolate flakes;
b. the about 25-26% of one or more types of flour comprises:
i. about 24-25% white flour; and
ii. about 0.0-1.0% pre-gel corn flour;
c. the about 19-20% sweetener comprises:
i. about 18-19% sugar; and
ii. about 0.0-1.0% dextrose;
d. the about 1.3-1.4% of a leavening system comprising one or more chemical leavening agents comprises:
i. about 0.6% soda;
ii. about 0.3% dicalcium phosphate; and
iii. about 0.5% SALP; and
d. the emulsifier agent is a MYVATEX brand emulsifier blend.

7. A muffin batter having substantial stability to temperature fluctuations experienced in a commercial retail setting comprising:
a. from about 7.5% to about 22.5% of a flavorant mix;
b. from about 19% to about 22% water;
c. from about 15% to about 27% of one or more types of flour;
d. from about 16.5% to about 21.0% sweetener;
e. from about 10.5% to about 13.5% liquid whole eggs;
f. from about 8.5% to about 10.5% oil;
g. from about 1.2% to about 1.9% of a leavening system comprising one or more chemical leavening agents;
h. from about 0.0% to about 1.5% of texture agent; and
i. from about 0.2% to about 0.5% carrageenan.

8. The muffin batter of claim 7 wherein the flavorant mix is selected from the group consisting of fruits, vegetables, fruit-fibers, vegetable-fibers, bran, fruit-puree, vegetable-puree, chocolate chips, chocolate flakes, chocolate morsels, and combinations thereof.

9. The muffin batter of claim 8 wherein the flavorant mix is selected from the group consisting of dried apples, raisins, shredded carrots, bran and combinations thereof.

10. The muffin batter of any one of claims 1-9 having substantial stability to temperature fluctuations spanning a range of from about 40° F. to about 70° F.

11. A muffin mix comprising the muffin batter of any one of claims 3, 4 or 7 and a muffin topping wherein the muffin topping comprises:
a. about 37% sugar;
b. from about 22% to about 29% flour;
c. about 21-22% of rolled oats;
d. from about 12% to about 18% shortening; and
e. one or more additional ingredients selected from butter flavor and cinnamon spice.

12. A muffin mix comprising the muffin batter of any one of claims 5-7 and a muffin topping wherein the muffin topping comprises:
a. about 91-92% of one or more sweeteners; and
b. about 8-9% cocoa.

13. The muffin mix of claim 12 wherein the one or more sweeteners of the muffin topping are selected from Turbinado sugar, Demerara sugar, molasses, or combinations thereof.

14. The muffin mix of claim 12 wherein the one or more sweeteners of the muffin topping comprises:
a. about 45.5-46.0% sugar; and
b. about 45.5-46.0% molasses.

15. A muffin package comprising a tray partitioned into a plurality of depressions, wherein a paper cup containing an individual serving-sized portion of the muffin batter of any one of claims 1-9 resides in each depression.

16. The muffin package of claim 15 wherein an individual serving-sized portion of the muffin batter is from about 90 grams to about 110 grams.

17. The muffin package of claim 16 wherein the tray is over-wrapped and sealed with plastic film.

18. A method for making a muffin batter having substantial stability to temperature fluctuations experienced in a commercial retail setting comprising:
a. sufficiently blending:
i. from about 7.5% to about 22.5% of a flavorant mix;
ii. from about 15% to about 27% of one or more types of flour;
iii. from about 16.5% to about 21.0% sweetener;
iv. about 3% oil;
v. from about 1.2% to about 1.9% of a leavening system comprising one or more chemical leavening agents;
vi. from about 0.0% to about 1.5% of emulsifier agent; and
vii. from about 0.2% to about 0.5% carrageenan to form a dry mix; and
b. sufficiently blending the dry mix with
i. from about 19% to about 22% water;
ii. from about 10.5% to about 13.5% liquid whole eggs; and
iii. from about 5.5% to about 7.5% oil to form the muffin batter.

19. The method of claim 18 wherein the flavorant mix is selected from the group consisting of fruits, vegetables, fruit-fibers, vegetable-fibers, bran, fruit-puree, vegetable-puree, chocolate chips, chocolate flakes, chocolate morsels, and combinations thereof.

20. The method of claim 18 for maling a muffin batter having substantial stability to temperature fluctuations of from about 40° F. to about 70° F.
